(19) United States
(12) Patent Application Publication
(10) Pub. No.: US 2025/0314548 A1
(43) Pub. Date: Oct. 9, 2025

(54) GLOVE INTEGRITY TESTING DEVICE

(71) Applicant: Norco Industries, Inc., Compton, CA (US)

(72) Inventors: Jeff Romero, Middlebury, IN (US); Frank Casale, Fishers, IN (US)

(73) Assignee: Norco Industries, Inc., Compton, CA (US)

(21) Appl. No.: 19/069,176

(22) Filed: Mar. 3, 2025

Related U.S. Application Data
(60) Provisional application No. 63/631,066, filed on Apr. 8, 2024.

(51) Int. Cl. G01M 3/02; G01M 3/26

(52) U.S. Cl. CPC G01M 3/027; G01M 3/26

(57) ABSTRACT

A glove testing system is disclosed for use with a supply of compressed air, the system including a disk-shaped plate having a rubber outer surface and a central aperture. First and second interlocking members connect on each side of the plate and one interlocking member connects to the supply of compressed air. An internal channel communicates the compressed air from the first interlocking member to the second, and then to the glove's interior, where the pressure can be monitored for leaks to evaluate the integrity of the glove.

### CROSS-REFERENCES TO RELATED APPLICATIONS

This application claims priority to U.S. Provisional Patent Application No. 63/631,066, filed Apr. 8, 2024, the content of which is incorporated by reference herein in its entirety.

### BACKGROUND

Mechanics and service technicians frequently work near sources of electricity such as the powerful battery of a vehicle's engine. Wearing gloves is an important safety measure to prevent electrical shocks when working in such proximity to electricity. Since gloves can often be damaged and even small ruptures can be the source of electricity transfer, it is important to regularly verify the integrity of such gloves prior to use.

When checking gloves used around electricity for leaks, it is crucial to follow a thorough and meticulous process to ensure the safety of the user. The first step is typically to carefully inspect the gloves for any signs of physical damage, such as cuts, punctures, or tears. Even the smallest imperfection can compromise the integrity of the glove and increase the risk of electrical shock. After a visual inspection, in the past gloves would be filled with air and then submerged in water to detect any leaks. While submerged, the gloves are carefully examined for tiny air bubbles that would indicate the presence of a hole in the glove. Any gloves found to have leaks are immediately taken out of service and replaced to prevent potential electrical hazards. However, sometimes it is impractical or unfavorable to submerge gloves in water prior to their use.

In addition to regular visual and water tests, gloves used around electricity should be tested with an electronic glove tester to ensure their electrical insulation properties are intact. This test involves applying a specific voltage to the gloves and measuring the resulting current flow. Any abnormal readings could indicate a flaw in the gloves' insulation, indicating a hole in the glove allowing current to transfer across the glove barrier. By performing these comprehensive tests and inspections, the integrity of the gloves can be maintained, and the safety of personnel working with electricity can be effectively safeguarded.

The present invention pertains to a glove testing device that inflates the glove and checks for drops in pressure that would indicate a leak somewhere on the glove. If a leak is detected, the glove can be either repaired or replaced.

### SUMMARY OF THE INVENTION

The present invention is a device comprised of a metallic plate with a central aperture that receives a pair of interlocking handles. The handles communicate air pressure across the plate via a source of compressed air introduced at an end of one of the handles. The compressed air is transferred to the glove under testing in an airtight condition and the pressure is monitored to determine if the pressure is dropping in the glove, indicating a leak. Multiple plates are preferably provided in a kit to permit selection of the best size plate for the particular glove.

### DESCRIPTION OF THE DRAWINGS

FIG. 1 is an elevated, perspective view of a first preferred embodiment of the present invention;

FIG. 2 is an exploded view of a kit incorporating the present invention;

FIG. 3 is an exploded view of the disk and handles of the present invention;

FIG. 4 is a cross sectional view of the glove, disk, and handles in a testing environment; and

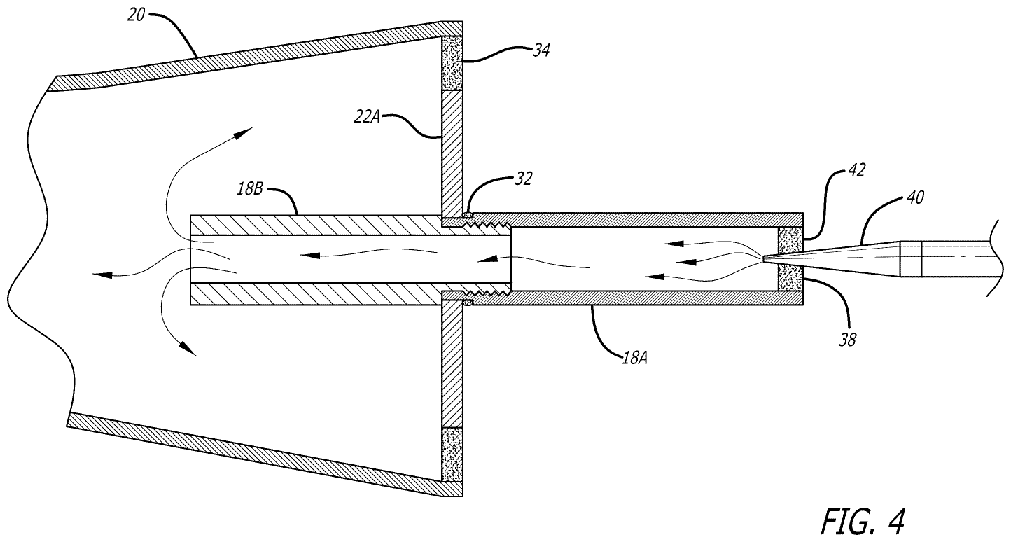

FIG. 5 is an elevated, perspective view of the glove under testing.

### DETAILED DESCRIPTION OF THE PREFERRED EMBODIMENTS

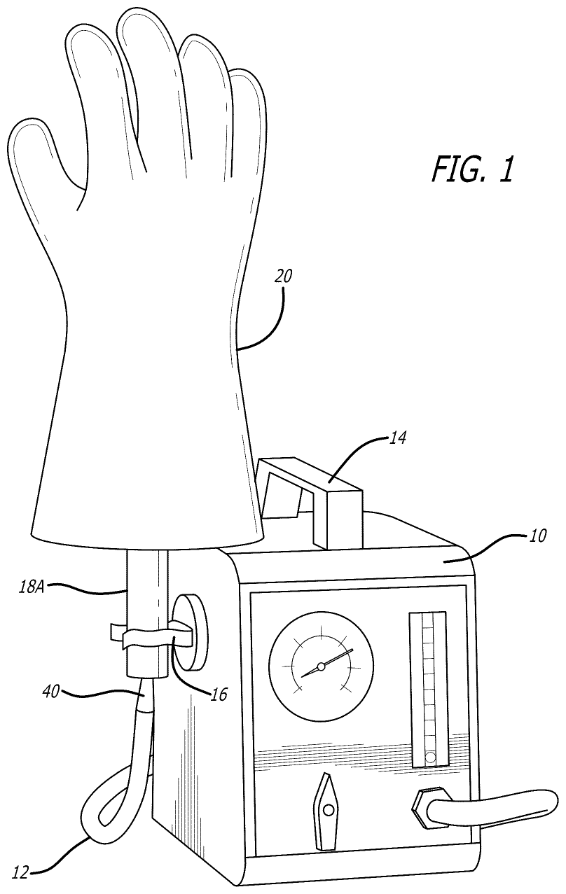

The present invention can be used in conjunction with leak detection systems such as the LPLT-100 low pressure leak tester offered by Flo-Dynamics of Elkhart, Indiana. FIG. 1 shows an air flow meter 10 that can monitor the pressure of a confined volume (such as an inflated glove) with an air hose 12. The flow meter 10 is formed with a carrying handle 14 and a bracket 16. In the bracket 16 is a first handle 18A that is used with a disk to seal a glove 20.

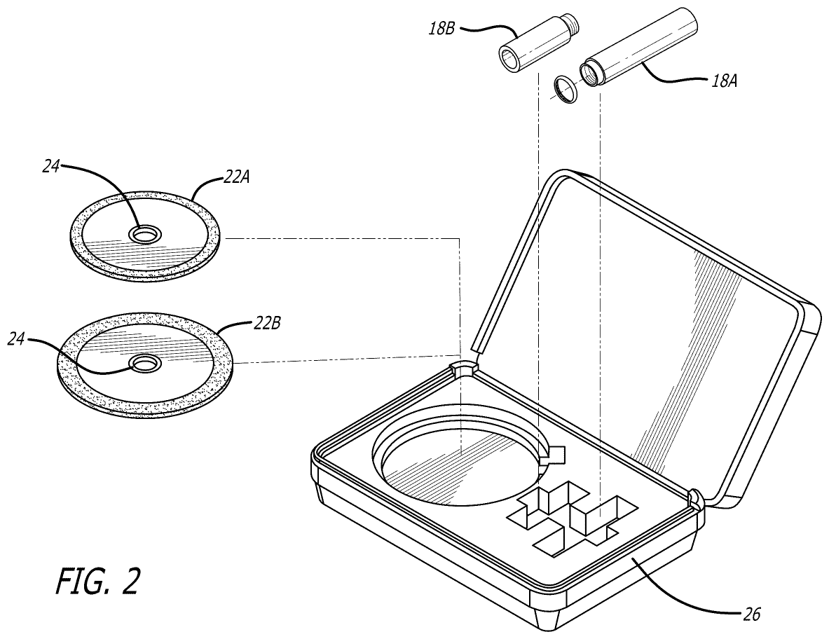

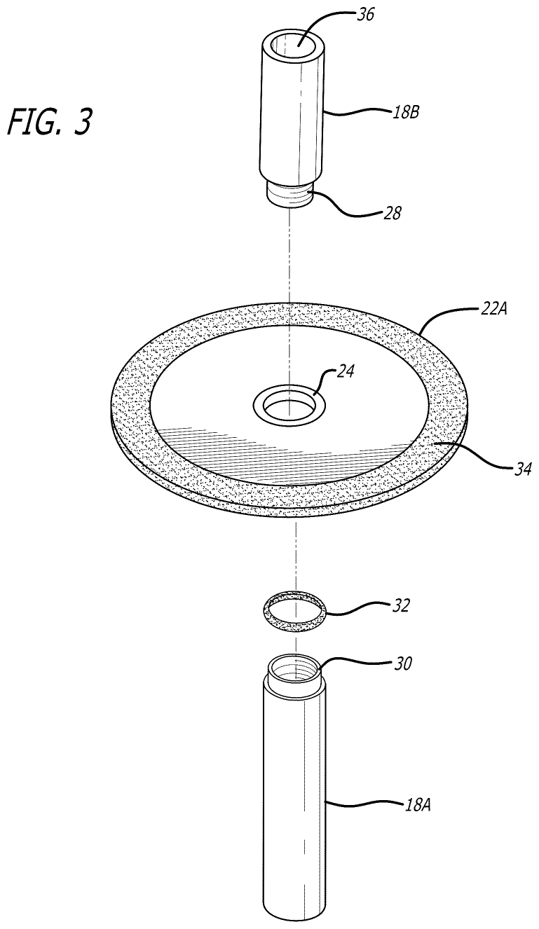

The invention can be used with shop air (75-175 psi) to supply a constant pressure up to 14″ WC +/−1 inch with 100% filtered and moisture free air. The flow meter 10 provides two testing modes-leak flow rate or pressure decay. FIG. 2 illustrates a convenient kit for carrying out the glove test. The kit comprises two rigid plates 22A, 22B each having a central aperture 24, into which first and second interlocking handles 18A, 18B are inserted. The disks and handles are stored in a case 26 with a foam bed having sized recesses for the components. FIG. 3 shows the connection of the two handles 18A, 18B inside the aperture 24 of the plate 22A. Shorter plate 18B has a threaded male portion 28 that passes through the aperture 24 and is received in handle 18A within a threaded female portion 30. A polymeric O-ring 32 is located at the juncture of the two handles 18A, 18B to seal the connection and prevent air from leaking across the juncture. The two handles are hollow and provide a passage for air to flow through and across the plate 22A. The two handles interlock to form a rigid air conduit using the threaded surfaces.

The outer surface of the handles preferably have a knurled texture to facilitate gripping of the handles. The plate 22A has a rubber seal 34 around its circumference to form a better seal with the glove's inner surface. At one end of the handle 18B is an outlet 36 that communicates with the internal channel. The proximal end of the handle 18A is formed with an inlet port 38 that mates with the hose 12 of the LPLT-100 or flow meter 10 to transmit pressurized air into the handle. In some embodiments, a magnet is used to couple the LPLT-100 to the handle 18A for hands-free testing.

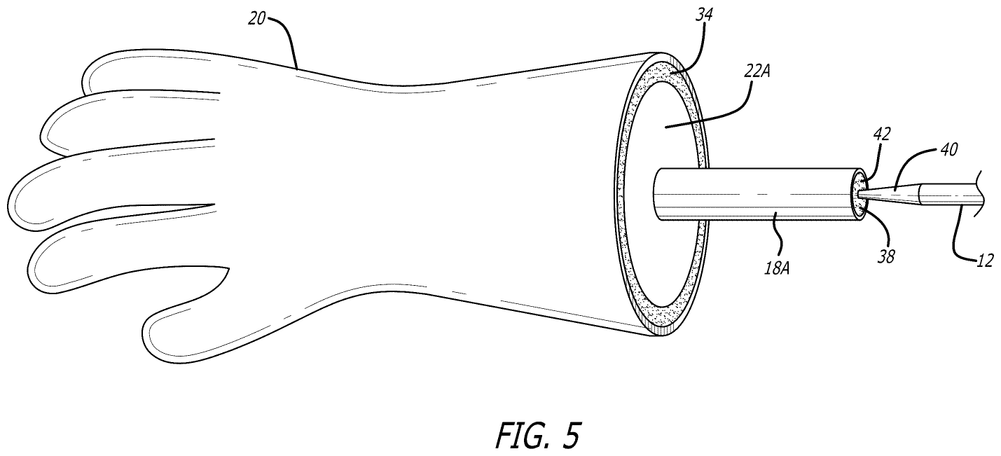

The procedure for testing the glove will now be explained. First, a user selects the plate that best fits the size glove being tested. It is best to also inspect the long handle 18A to ensure that the rubber O-ring 32 on the threaded end and in place. One then positions the center hole 24 of plate 22A over the handle 18B's threaded male end, and the handle 18A's female threaded end receives the handle 18B's male end. The two handle components are then tighten securely by hand to clamp the plate 22A between the two handles. With the two handles and plate in this configuration, one holds the handle 18A in one's off hand and uses one's dominant hand to stretch the base of the rubber glove over the rubber seal 34 of plate (see FIG. 5).

With the glove tightly fitted over the plate, the adapter 40 of the LPLT-100 hose is inserted into the rubber plug 42 of the handle 18A. The plate 22A should be positioned very close to glove opening to maximize the area of the glove being tested. Testing can now be conducted. Air will be transmitted through the handles to the glove's interior, thereby inflating the glove. The LPLT-100 flow meter detects any drop in pressure due to a leak and signals the user if this is the case. When the test is complete, the glove is removed and a new glove can be tested.

While the fundamental operation and aspects of the invention have been described, the invention is not limited to the exact embodiments depicted and described herein. A person of ordinary skill in the art will readily recognize and appreciate that there are various substitutions, modifications, and alterations that can be made to the above described embodiments without departing from the spirit of the invention, and the inventor intends all such substitutions, modifications, and alterations to be incorporated into the scope of the patent.

I claim:

1. A glove testing system, comprising:
a supply of compressed air;
a flow meter;
a disk-shaped plate having a flexible rubber outer portion and a central aperture;
first and second interlocking hollow tubular members threadingly joined at said central aperture of the disk-shaped plate, said first second interlocking members including a connected inner channel accessible at a first port;
a glove engaged with the disk-shaped plate to form an airtight seal;
wherein air from the supply of compressed air passes through the first and second interlocking hollow tubular members to inflate an interior of the glove; and
wherein the flow meter determines a presence or absence of a leak in the glove by evaluating pressure loss across the disk-shaped plate.

2. The glove testing system of claim 1, wherein said first interlocking tube is formed with a rubber plug at a first end.

3. The glove testing system of claim 2, wherein the rubber plug is adapted to receive an adapter of the flow meter to form an airtight seal.

4. The glove testing system of claim 1, wherein the supply of compressed air is the flow meter.

5. The glove testing system of claim 1, wherein the system includes a plurality of disk-shaped plates of differing diameters to perform testing on different sized gloves.

6. The glove testing system of claim 5, further comprising a carrying case for enclosing the interlocking hollow tubular members and the plurality of disk-shaped plates therein.
